(19) United States
(12) Patent Application Publication
(10) Pub. No.: US 2004/0230611 A1
(43) Pub. Date: Nov. 18, 2004

(54) Electronic data record of an invoice, the record having a dunning key

(76) Inventors: Mike Soumokil, Vught (NL); Guido Rietveld, Den Bosch (NL)

Correspondence Address: Finnegan, Henderson, Farabow,, Garrett & Dunner, L.L.P., 1300 I Street, N.W., Washington, DC, 20005-3315, US

(21) Appl. No.: 10/770,423

(22) Filed: Feb. 4, 2004

(30) Foreign Application Priority Data
Feb. 7, 2003 (EP) 03002793.2

(51) Int. Cl. G06F 17/00

(52) U.S. Cl. 707/104.1

(57) ABSTRACT

An electronic data record contains data of an invoice, the record including a plurality of data fields, comprising a data field for characterization of the state of the processing of the invoice. According to one embodiment, a method is provided for processing the electronic data record by means of one or more processes running in a computer system, the method comprising calling a dialogue for entering a state by a user.

### FIELD OF THE INVENTION

The technical field of this invention is in the area of electronic data processing. More particularly, the invention relates to methods, computer program products and systems for electronic data records of invoices.

### BACKGROUND OF THE INVENTION

Electronic data records of invoices are known from the state-of-the-art. They are used in enterprise resource planning (ERP) software to store the financial data related to a sale of a product and to have such data available for credit management and risk management purposes. However, although the data are stored in the computer system of the respective enterprise, it is not in any case certain whether the invoice has been actually paid, whether the dispute has been opened on the invoice or on the whole sale or on the order process or on contract issues or other problems that will prevent a payment of an invoice. Consequently, if the management of the enterprise analyses the financial situation on the basis of the uncertain data of the invoices, the result may be misleading and may show that financial situation of the enterprise is different from the actual financial situation.

From a technical point of view, the performance of a computer system, which handles the processing of thousands of invoices (e.g., tens of thousands or more), is stressed by a high load of complex queries in order to retrieve the above-mentioned information.

Thus, there is the need for an electronic data record for invoices, which provides a more exact picture of the state of an invoice, and there is further a need to provide a more efficient solution of processing the invoices with a computer system in order to reduce its load and gain performance and availability.

### SUMMARY OF THE INVENTION

As embodied and broadly described herein, methods and systems consistent with the principles of the invention provide an electronic data record containing data of an invoice, the record including a plurality of data fields, comprising a data field for characterization of the state of the processing of the invoice (dunning key).

In accordance with another aspect, as embodied and broadly described herein, methods and systems consistent with the principles of the invention provide a method for processing an electronic data record by means of one or more processes running in a computer system, wherein the method comprises calling a dialogue for entering a state by a user.

By using the inventive electronic data records and methods in business software, e.g., ERP software, the management of a respective enterprise can get an improved day sales outstanding, a better management of liquidity, an improved credit risk management through more transparency, better customer profiling through company owned credit scores, better accounts receivable reporting, and/or better communication with customers. Furthermore, the complexity of queries that the computer system of the enterprise has to deal with is reduced, although the storage requirement might be slightly increased. In consequence, the performance and availability of the computer system is increased. This results in total in a reduction of costs.

Embodiments of the invention are also directed to data structures having electronic data records and to computer systems, computer programs, computer-readable medium and carrier signals comprising instructions for processing data according to the inventive methods and its embodiments, respectively. Further, embodiments of the invention are directed to the use of the claimed data structures in accounting software and computer systems.

Additional objects and advantages of the invention will be set forth in part in the description, or may be learned by practice of the invention. The objects and advantages of the invention will be realized and attained by means of the elements and combinations particularly pointed out in the appended claims. Embodiments of the invention are disclosed in the detailed description section and in the claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and, together with the description, explain the principles of the invention. In the drawings:

FIG. 1 is a schematic block diagram of an exemplary implementation of the inventive electronic data record within a computer system; and

FIG. 2 illustrates, in block diagram form, an exemplary implementation of the inventive electronic data record and its possible links.

### DETAILED DESCRIPTION

Within the concept of this disclosure, the terms used shall have their usual meaning in the context of the field of data processing, unless defined otherwise. Particularly, a computer system broadly refers to any stand alone computer such as a personal computer (PC) or a laptop or a series of computers connected via a network, e.g., a network within a company or a series of computers connected via the Internet. Computer systems and programs may be closely related. As used herein, phrases, such as “the computer provides,” “the program provides or performs specific actions,” and “a user performs a specific action” are used to express actions by a computer system that may be controlled by a program, to express that the program or program module may be designed to enable the computer system to perform the specific action, or to enable a user to perform the specific action by means of a computer system.

In this context, the term “automatically” is not intended to exclude a user's interactions with the computer system in the course of processing.

Within the concept of embodiments of the invention, the terms used shall have their usual meaning in the context of the field of data processing, unless defined otherwise in the following section.

In computer programming languages, an inventive electronic data record may be implemented as one or more lines of one or more tables, each line having one or more fields. In object-orientated programming, an electronic data record may be implemented by an instance of a class. The class may have a plurality of variables and at least one variable for the state of the invoice. The class may further have one or more functions, which are operable on the instances (invoices). The fields or variables contain typical invoice information such as the name of a customer, addresses, product, price, account no., payment terms, tax, contact person, invoice date, due date, person responsible for changes in the document on the customer side or responsible person for authorization. According to an aspect of the invention, the electronic data record may comprise a data field for characterization of the state of the processing of the invoice. The state field may be implemented as a string field with a length of 1 to 3 or more characters, depending on the number of possible states. By way of non-limiting examples, the following states may be characterized: cash collection status, special attention, problem indicators on contract issues or on invoice content, layout issues, issues to be handled by responsible managers or on escalated matters, internal status, number of days outstanding, or payment date of document. These states are examples and not intended to limit the scope of the invention.

According to an embodiment of the invention, an electronic data record may be provided that includes a data field. The data field may contain one or more characters for the characterization of a state. The above-mentioned states may be entered into the state field by entering a characteristic character or combination of a few characters into the field, e.g., S1 to Sn for the states 1 to n.

In accordance with another embodiment of the present invention, an electronic data record may be provided that comprises a data field linked to a table, which contains a description of a state. By way of non-limiting examples, the following descriptions can be entered in that table: cash collection status or on special attention or as problem indicators on contract issues or on invoice content and lay-out issues or on issues to be handled by responsible managers or on escalated matters.

A further embodiment of the electronic data record comprises a data field that is directly or indirectly linked to a table, wherein the table contains one or more instructions which depend on the state and are automatically executable by a computer system.

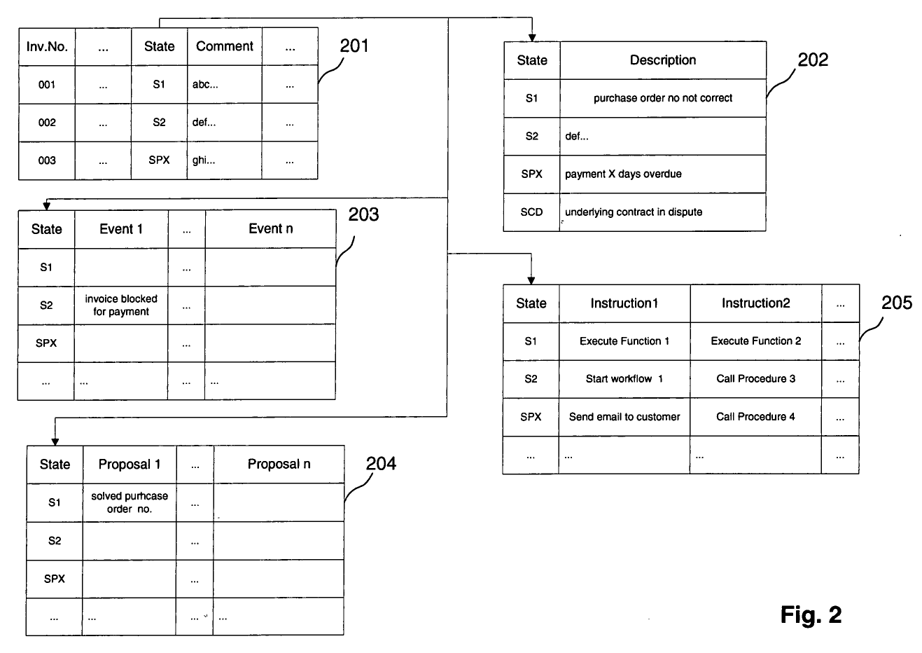

Another embodiment of the electronic data record comprises a data field that is directly or indirectly linked to a table containing an assignment of a state to an event, which might occur during the processing of the invoice. By way of non-limiting examples, the following events may be typically contained: invoice blocked for payment, because invoice lay-out not complete or incomplete invoice reference or quality or quantity issues on outstanding documents to be solved by a responsible person within the company. These events are examples and are not intended to limit the scope of this invention. By means of a table (see, e.g., table 204 in FIG. 2), one or more proposals 1 to n for a change of the state may be assigned to a state.

In a further embodiment, the electronic data record comprises a data field for comments. This comment field may be implemented as a string field of a length of up to 128 characters or more.

A further embodiment of the invention relates to an electronic data record that is at least partially accessible via the Internet and wherein the content of the data field for the state or a data field for comments is editable via the Internet. In order to achieve this, the respective data fields may be unblocked for read/write access in the computer system in which the electronic data record is processed. Other selected fields of the electronic data record, the content of which fields may be of interest for a potential Internet user, may be unblocked for read access only.

A further embodiment of the electronic data record comprises a data field for a state linked to a table, which contains one or more state-dependent proposals for changing the state. For example, if the state is that a document has to be authorized by a responsible manager, a proposed state after authorization is that the state may be changed in “to be paid.” Another example is if a purchase order number is not correct, it may have the state “missing purchase order number.” After correction, it may have the state “solved purchase order number.”

Still another embodiment of the present invention relates to a method for processing electronic data records. The method may comprise the step of assigning the state entered by the user to the data field for the state. This may be implemented by an independent program, which may collect all changes of states in a predefinable time interval and write the changes periodically into the respective state fields.

Another embodiment of the present invention provides a method for processing electronic data records, wherein the method comprises selecting, sorting, evaluating and/or analyzing the electronic invoices according to the state.

By using this method and general known database query tools, a user of the inventive method may get lists of all invoices, which fulfill predefinable conditions with respect to the status field, e.g., outstanding invoices, which are not likely to be paid at all, of incorrect pricing or on incorrect quality or on incorrect quantity or on wrong address or on wrong purchase order or on incorrect contract or on bankruptcy or documents given to collection agency. These results are useful for the evaluation of the company's accounts receivable, credit risk operation risk or for the evaluation of the paying habits of customers or on the solving time of internal departments, the number of incorrect documents by the status group, and/or the value of the incorrect documents.

Another embodiment of the present invention provides a method for processing electronic data records, wherein the method comprises calling a state dependent workflow.

By using this method, a workflow, which is designed to solve a specific problem, may be automatically initiated. For example, a dispute process can be initiated if the customer sets a specific state via the Internet. Then mail may be automatically sent to a caseworker in order to solve the problem. Furthermore, a deadline can be issued on an outstanding problem. After an experiment date, the system may automatically send a reminder to the responsible person(s) to take action. Further, a to-do list can be initiated for cash collectors on outstanding items or for sending mail to responsible contact persons with the customers.

A further embodiment of the present invention enables a state to be selectable according to predefinable events. This may give a user a hint for entering the correct state into the system. The predefinable events may be displayed on a screen. Further, the user may select events by an interaction with the computer (mouse click, keyboard stroke, etc.) and then the computer system may automatically enter the state linked with the predefinable events into the state field.

A still further embodiment of the invention provides a method for processing electronic data records, wherein the method is for use in or with enterprise resource planning software. The term “enterprise resource planning software” herein broadly refers to any software or software package for supporting business processes of enterprises, including but not limited to accounting, administration, management, or production processes.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive, data from or transfer data to, or both, one or more mass storage devices (storage means) for storing data, e.g., magnetic, magneto-optical disks, or optical disks. Information carriers suitable for embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

Reference will now be made in detail to the principles of the invention by explaining the invention on the basis of the accompanying drawings.

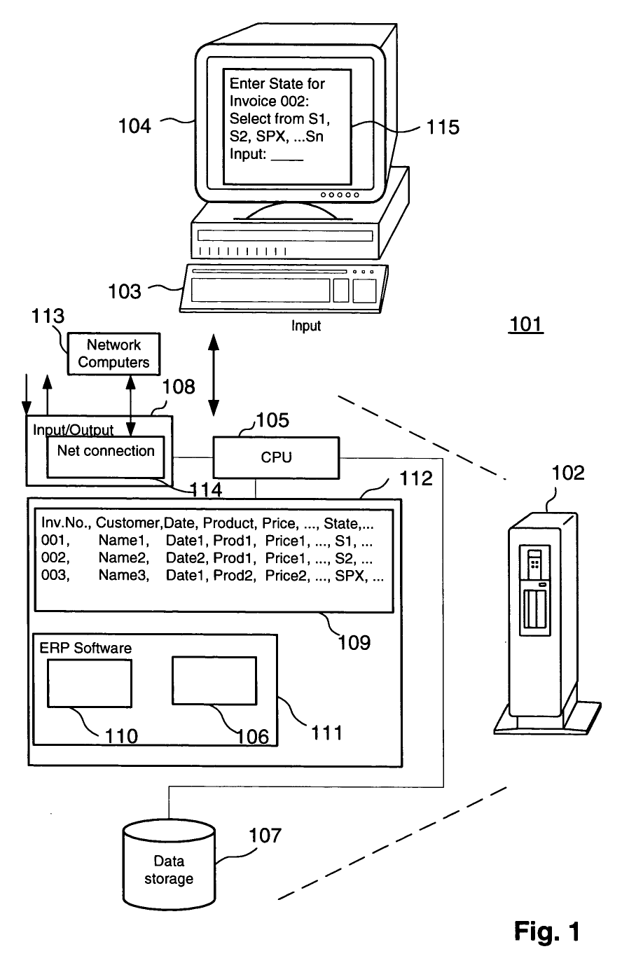

FIG. 1 depicts an exemplary implementation of an embodiment of the invention comprising a computer system with program modules for processing the inventive electronic data records and for performing the inventive methods. In particular, FIG. 1 shows a computer system 101 comprising a computer 102 including a CPU 105, a working storage 112 (memory), in which a software application 111 is stored for being processed by CPU 105. Software application 111 comprises program modules 106, 110 for carrying out the processing of the inventive electronic data records and the processing according to the inventive methods. The inventive electronic data records may be implemented in a table 109, comprising a column for typical invoice data and a column for the state of the invoice. Table 109 is stored in computer memory 112 and/or in a non-volatile data storage device 107. Computer system 101 further comprises input means 103, output means 104 for interaction with a user, e.g., for starting the program modules and/or for data input, and general input/output means 108, including a net connection 114, for sending and receiving data. A plurality of computer systems 101 can be connected via the net connection 114 in the form of a network 113. In this case, the network computers 113 can be used as further input/output means, including the use as further storage locations. Computer system 101 further comprises storage means 107.

In case the ERP software 111 carries out the inventive methods, program modules 106 and 110 are processed by CPU 105. The inventive processing comprises displaying a dialogue window 115 for entering a state for a electronic data record by process 106. The entered value of the state is given to a process 110, which writes the entered state into a database in which the electronic data records are administrated. Further software modules may be available in the ERP software 111 for performing analyses of the electronic data records.

FIG. 2 illustrates an exemplary implementation of a data structure 201 of an invoice. The data structure may be implemented as a table having a plurality of columns. According to an aspect of the invention, a column for the state of the invoice is contained. In the embodiment of FIG. 2, the individual data records of the invoices are implemented as individual lines of table 201. In a table 202, a description is assigned to a state. By means of table 203, one or more events 1 to n are assigned to a state. By means of table 204, one or more proposals 1 to n are assigned to a state. By means of table 205, one or more instructions 1 to n are assigned to a state. Tables 202 to 205 may be linked to table 201 by the state column.

Modifications and adaptations of the present invention will be apparent to those skilled in the art from consideration of the specification and practice of the invention disclosed herein. The foregoing description of implementations of the invention has been presented for purposes of illustration and description. It is not exhaustive and does not limit the invention to the precise embodiments or forms disclosed. Modifications and variations are possible in light of the above teachings or may be acquired from the practicing of the invention. For example, the described implementations include software, but systems and methods consistent with the present invention may be implemented as a combination of hardware and software or in hardware alone. Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of Java, C++, HTML, XML, or HTML with included Java applets or in SAP R/3 or ABAP. One or more of such modules can be integrated in existing e-mail or browser software.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as nonexclusive. For example, in the present disclosure, the term “preferably” is nonexclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An electronic data record comprising data of an invoice, the record including a plurality of data fields, the plurality of data fields comprising:
a data field for characterization of a state of the processing of the invoice.

2. The electronic data record of claim 1, wherein the data field comprises one or more characters for the characterization of the state.

3. The electronic data record of claim 1, wherein the data field is linked to a table, which comprises a description of the state.

4. The electronic data record of claim 1, wherein the data field is directly or indirectly linked to a table, the table comprising one or more instructions which depend on the state and are automatically executable by a computer system.

5. The electronic data record of claim 1, wherein the data field is directly or indirectly linked to a table, the table comprising an assignment of the state to an event which can occur during the processing of the invoice.

6. The electronic data record of claim 1, wherein the electronic data record is at least partially accessible via the Internet and wherein the content of the data field for the state or a data field for comments is editable via the Internet.

7. The electronic data record of claim 1, wherein the data field for the state is linked to a table, the table comprising one or more state dependent proposals for changing the state.

8. A method for processing an electronic data record containing data of an invoice, the electronic data record including a plurality of data fields, the plurality of data fields comprising a data field for characterization of a state of the processing of the invoice, the method being performed by one or more processes running in a computer platform and comprising:
calling a dialogue for entering a state by a user.

9. The method of claim 8, further comprising:
assigning the state entered by the user to a data field for the state.

10. The method of claim 8, further comprising:
performing at least one of selecting, sorting, evaluating, and analyzing the electronic invoice according to the state.

11. The method of claim 8, further comprising:
calling a state dependent workflow.

12. The method of claim 11, wherein the state is selectable according to predefinable events.

13. The method of claim 8, wherein the method is for use in business software, particularly in an enterprise resource planning software.

14. A computer system for processing an electronic data record containing data of an invoice, the electronic data record including a plurality of data fields, the plurality of data fields comprising a data field for characterization of a state of the processing of the invoice, the computer system comprising:
memory including program instructions;
input means for entering data;
storage means for storing data; and
a processor responsive to the program instructions for calling a dialogue for entering a state by a user.

15. The computer system of claim 14, further comprising program instructions for assigning the state entered by the user to a data field for the state.

16. The computer system of claim 14, further comprising program instructions for performing at least one of selecting, sorting, evaluating, and analyzing the electronic invoice according to the state.

17. The computer system of claim 14, further comprising program instructions for calling a state dependent workflow.

18. The computer system of claim 17, wherein the state is selectable according to predefinable events.

19. The computer system of claim 14, wherein the computer system is for use with business software, particularly with an enterprise resource planning software.

20. A computer-readable medium comprising instructions for processing an electronic data record containing data of an invoice, the electronic data record including a plurality of data fields, the plurality of data fields comprising a data field for characterization of a state of the processing of the invoice, the computer-readable medium comprising instructions for:
calling a dialogue for entering a state by a user.

21. The computer-readable medium of claim 20, further comprising instructions for:
assigning the state entered by the user to a data field for the state.

22. The computer-readable medium of claim 20, further comprising instructions for:
performing at least one of selecting, sorting, evaluating, and analyzing the electronic invoice according to the state.

23. The computer-readable medium of claim 20, further comprising instructions for:
calling a state dependent workflow.

24. The computer-readable medium of claim 24, wherein the state is selectable according to predefinable events.

25. The computer-readable medium of claim 20, wherein the computer-readable medium comprises enterprise resource planning software.

26. A computer data signal embodied in a carrier wave comprising:
code for processing an electronic data record by means of one or more processes, the electronic data record containing data of an invoice, the electronic data record including a plurality of data fields, the plurality of data fields comprising a data field for characterization of a state of the processing of the invoice,
wherein the code comprises instructions for linking the data field directly or indirectly to a table, the table containing an assignment of a state to an event which can occur during the processing of an invoice.

27. A computer data signal embodied in a carrier wave comprising:
code for processing an electronic data record by means of one or more processes, the electronic data record containing data of an invoice, the electronic data record including a plurality of data fields, the plurality of data fields comprising a data field for characterization of a state of the processing of the invoice,
wherein the code comprises instructions for calling a dialogue for entering a state by a user.

28. An electronic data structure for an electronic data record according to any one of claims 1 to 7.

29. An electronic data structure according to claim 28, wherein the electronic data structure is for use with enterprise resource planning software.
